(19) United States
(12) Patent Application Publication
(10) Pub. No.: US 2014/0096796 A1
(43) Pub. Date: Apr. 10, 2014

(54) MOTORIZED HANDHELD POLISHING AND CLEANING APPARATUS

(71) Applicant: Hanan Frum, Pardesia (IL)

(72) Inventor: Hanan Frum, Pardesia (IL)

(21) Appl. No.: 14/114,915

(22) PCT Filed: May 24, 2012
(86) PCT No.: PCT/IB2012/052592

§ 371 Date: Oct. 31, 2013

Related U.S. Application Data
(60) Provisional application No. 61/489,273, filed on May 24, 2011.

(51) Int. Cl. B08B 1/04; B24B 23/02; B24B 7/18; B08B 1/00

(52) U.S. Cl. CPC B08B 1/04; B08B 1/002; B08B 1/006; B24B 23/02; B24B 7/186
USPC 134/6; 15/97.1; 15/4; 451/359; 451/59

(57) ABSTRACT

A motorized lightweight handheld polishing and cleaning apparatus used to clean and polish large and hard to access surfaces and a motorized method for cleaning and polishing large and hard to access surfaces are disclosed. The motorized lightweight handheld polishing and cleaning apparatus includes (a) a body, further comprising a motor used to rotate a cleaning disk, (b) a cleaning disk attached to a rotary axis of a vertical gear of said motor and (c) at least one handle.

### FIELD OF THE INVENTION

The invention relates generally to a motorized handheld cleaning and polishing apparatus, and more particularly, the present invention relates to a motorized handheld cleaning and polishing apparatus used for cleaning and polishing large and hard to access surfaces.

### BACKGROUND OF THE INVENTION

The present invention provides enhanced cleansing capabilities of surfaces in homes, offices and vehicles.

There are several known motorized cleaning and/or polishing apparatuses known in the art. Due to deficiencies of the motorized apparatuses known in the art, manual cleaning and polishing is still prevalent in both the home and in use with vehicles.

Often, arduous labor is involved in manual cleaning and/or polishing by way of cloth rags and paper of various types of wipers which invariably leave wiping marks and or “streaks” and do not polish efficiently.

Electrically operated hand-held apparatuses, are also known in the art. Such apparatuses utilize rotation and “trapping” of particles but suffer from inability to provide efficient polishing of large surfaces in a wet environment and with cleaning solvents and are thus inefficient in cleaning and polishing large windows and mirrors surfaces.

Other apparatuses exist, which do not incorporate rotary cleaning and are inefficient for most users in cleaning large vertical surfaces such as windows, counter tops and the like, glass panes, windshields and mirrors.

A further class of electrical brushes based on rotary cleaning for scrubbing and cleaning small surfaces are known in the art. Such apparatuses are geared towards elevated or grooved surfaces. However, brushes of this class are not suitable for cleaning and polishing large flat surfaces and high vertical surfaces that may be hard to access such as windows, glass panes, windshields and mirrors.

Several handheld electrical devices are known in the art for cleaning and polishing of kitchen utensils, ovens, table top surfaces ceramics, and toilets. However, these devices are insufficient for cleaning and polishing large surfaces and large vertical surfaces/high vertical surfaces such as windows, glass panes, windshields and mirrors.

Prior art cleaning and polishing apparatuses invariably suffer from one or more of the latent deficiencies, including but not limited to: a small cleaning heads; insufficient for cleaning large surfaces and especially windows, glass panes, windshields and mirrors; insufficient capability for polishing the surface after the scrubbing/cleaning operation; a cleaning head incapable of three dimensional and elastic self adjustment to the surface; an insufficient rotary speed in RPM; an insufficient power in torques; and an insufficient size, height or “reach” for effectively cleaning large/high surfaces; an incapability of utilizing a magazine of disposable pads for polishing and cleaning, wherein the pads are substantially formed of recycled materials such that preferably each used pad is removed after use thereby “revealing” a fresh pad.

A further class of pneumatic apparatuses is known, geared towards cleaning and polishing smooth surfaces and especially for cleaning and polishing vehicles. Nevertheless, such apparatuses are large and cumbersome industrial equipment and are not suitable for easy comfortable handheld operation. Such apparatuses are essentially inoperable for single handed use. Moreover, such apparatuses are invariably dependent on large power sources.

Steam generating apparatuses known in the art suffer from latent deficiencies which lend such apparatus not suitable for single handed and/or uni-dexterous use and are commonly reliant on large power sources.

There is therefore a need for a motorized handheld, ergonomic and lightweight apparatus, powerful and geared towards single hand use and capable of replacing cleaning “heads” and or cleaning/polishing pads. There is therefore an unmet need for providing such a motorized apparatus capable of cleaning large and hard to access surfaces.

There is a further need for such a motorized apparatus for domestic use and/or office environment for cleaning/polishing windows, mirrors, tables, counter tops and the like and substantially reducing and/or alleviating the need for manual scrubbing/scouring.

### SUMMARY OF THE INVENTION

A motorized lightweight handheld polishing and cleaning apparatus used to clean and polish large, vertical and hard to access surfaces and a method for cleaning and polishing large and hard to access surfaces are disclosed. The motorized lightweight handheld polishing and cleaning apparatus includes (a) a body, further includes a motor used to rotate a cleaning disk, (b) a cleaning disk operationally attached to a rotary axis of a vertical gear of the motor and (c) at least one handle.

According to a further feature of an embodiment of the present invention, the motorized lightweight handheld polishing and cleaning apparatus may include further a multi-layer cleaning pad, wherein the multi-layer cleaning pad comprises a plurality of pads stacked together enabling removal of an outer worn out pad thereby revealing a fresh pad.

According to a further feature of an embodiment of the present invention, the multi-layer cleaning pad may be provided with an exterior release tabs for releasing the exterior layers and an interior release tabs for releasing the interior layers.

According to a further feature of an embodiment of the present invention, the multi-layer cleaning pad may be washable and intended for repeated multiple usages and may include further a brush.

According to a further feature of an embodiment of the present invention, the multi-layer cleaning pad may be disposable and may be constructed from degrading materials aimed for one time use.

According to a further feature of an embodiment of the present invention, the cleaning disk may include further an adhesive fixed to the cleaning disk bottom.

According to a further feature of an embodiment of the present invention, an external cleaning pads magazine may be provided wherein the upper side of each cleaning pad in the provided cleaning pads magazine may be coated with a thin nylon layer used to attach firmly the upper cleaning pad to the adhesive fixed to the cleaning disk.

According to a further feature of an embodiment of the present invention, the cleaning pads may include further an extended rim, sticking out beyond a perimeter of the cleaning disk by 1 to 15 millimeters, protecting the rotating cleaning disk and allowing the handheld lightweight polishing and cleaning apparatus to clean surface frames.

According to a further feature of an embodiment of the present invention, the cleaning pads may include further a sponge soaked with a cleaning liquid.

According to a further feature of an embodiment of the present invention, the multi-layer cleaning pad may be constructed from a material selected from the group consisting of: chamois, fabric, paper, muslin, nonwoven and abrasive material.

According to a further feature of an embodiment of the present invention, the motorized lightweight handheld polishing and cleaning apparatus at least one handle may be a built-in folded telescoping handle, allowing cleaning and polishing large, high and hard to access surfaces.

According to a further feature of an embodiment of the present invention, the lightweight handheld polishing and cleaning apparatus motor delivers a rotation speed of at least 350 RPM to the cleaning disk.

According to a further feature of an embodiment of the present invention, the lightweight handheld polishing and cleaning apparatus motor delivers a rotation speed of 420-540 RPM to the cleaning disk.

According to a further feature of an embodiment of the present invention, the motor rotary axis provides a stall torque of at least 1 kilogram per centimeter.

According to a further feature of an embodiment of the present invention, the motor rotary axis provides a stall torque of 4-6 kilograms per centimeter.

According to a further feature of an embodiment of the present invention, the cleaning disk may include a magnet for securing the cleaning disk to the rotary axis.

According to a further feature of an embodiment of the present invention, a plurality of cleaning disks is provided wherein the cleaning disks are detachable and replaceable.

According to a further feature of an embodiment of the present invention, the motorized lightweight handheld polishing and cleaning apparatus may further includes elastic disk fastener for securing the cleaning pads to the cleaning disk.

According to a further feature of an embodiment of the present invention, the cleaning disk cross section may resemble the letter W facilitating three dimensional displacements of the cleaning disk, reducing the friction coefficient, reducing the vibrations and enhancing the cleaning capabilities of the W shape cleaning disk.

According to a further feature of an embodiment of the present invention, the motorized lightweight handheld polishing and cleaning apparatus may include further a plurality of apertures formed in the W shape cleaning disk used to clear debris from the cleaned surfaces and to enhance ease of rotation of the cleaning disk.

According to a further feature of an embodiment of the present invention, the motorized lightweight handheld polishing and cleaning apparatus may include further a replaceable cleaning cartridge that provides cleaning and or polishing material and or liquid for further enhancing the cleaning and polishing capabilities of the cleaning disk and the multi-layer cleaning pads.

According to a further feature of an embodiment of the present invention, the power source may be selected from the group consisting of: external power source, batteries and rechargeable batteries.

According to a further feature of an embodiment of the present invention, the batteries my be selected from the group consisting of: AAA battery, AA battery, C cell battery, D cell battery and CR123 battery.

According to a further feature of an embodiment of the present invention, the motorized lightweight handheld polishing and cleaning apparatus may include further an electrostatic protected lanyard used further to protect and secure the motorized lightweight handheld polishing and cleaning apparatus from falling down.

According to a further feature of an embodiment of the present invention, a motorized method for cleaning and polishing surfaces is disclosed. The motorized method comprises the steps of (a) providing a motorized lightweight handheld cleaning and polishing apparatus comprising further a body, a cleaning disk, cleaning pads and at least one handle, (b) cleaning surfaces using the provided motorized lightweight handheld apparatus, and (c) replacing or washing the cleaning pads.

According to a further feature of an embodiment of the present invention, the motorized method may include further the step of providing an adhesive fixed to the cleaning disk bottom.

According to a further feature of an embodiment of the present invention, the motorized method may include further the step of providing an external cleaning pads magazine wherein the upper side of each cleaning pad in the provided cleaning pads magazine may be coated with a thin nylon layer used to attach firmly the upper cleaning pad to the adhesive fixed to the cleaning disk.

According to a further feature of an embodiment of the present invention, the surfaces that may be cleaned and polished may be glass, mirror, wooden, ceramic, marble and metal surfaces in homes, offices, hotels and vehicles.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a cross section of the motorized lightweight handheld apparatus with a telescoping handle in an open position, according to an embodiment of the present invention;

FIG. 2 illustrates a lengthwise cross-section of the motorized lightweight handheld apparatus and the cleaning disk, according to an embodiment of the present invention;

FIG. 3 illustrates the motorized lightweight handheld apparatus with a built-in telescoping handle in a folded position, according to an embodiment of the present invention;

FIG. 4 illustrates a cross-section of a multi-layered disposable cleaning pad, according to an embodiment of the present invention;

FIG. 5 illustrates an external cleaning pads magazine, according to an embodiment of the present invention;

### DETAILED DESCRIPTION OF THE PREFERRED EMBODIMENTS

A motorized lightweight handheld polishing and cleaning apparatus and a method for cleaning and polishing large, vertical and hard to access surfaces are disclosed. The motorized lightweight handheld polishing and cleaning apparatus includes (a) a body, further comprising a motor used to rotate a cleaning disk, (b) a cleaning disk operationally attached to a rotary axis of a vertical gear of the motor and (e) at least one handle.

According to embodiments of the present invention, the motorized lightweight handheld polishing and cleaning apparatus includes multi-layer cleaning pad that includes a plurality of pads stacked together enabling removal of the outer worn out pad thereby revealing a fresh pad. The multi-layer cleaning pad may be provided with exterior release tabs for releasing the exterior layers and interior release tabs for releasing the interior layers.

According to embodiments of the present invention, the multi-layered cleaning pad may be washable and intended for repeated multiple usage or may be disposable and may be constructed from degrading materials intended for one time use.

According to embodiments of the present invention, the motorized lightweight handheld polishing and cleaning apparatus may include further an adhesive fixed to the cleaning disk bottom.

According to embodiments of the present invention, the motorized lightweight handheld polishing and cleaning apparatus may be provided with an external cleaning pads magazine wherein the upper side of each cleaning pad in the provided cleaning pads magazine is coated with a thin nylon layer or other polymer used to attach firmly the upper cleaning pad to the adhesive fixed to the cleaning disk.

According to a further aspect of the present invention, certain embodiments provide a motorized method for cleaning and polishing large and hard to access surfaces. The motorized method comprising the steps of (a) providing a motorized lightweight handheld cleaning and polishing apparatus that includes further a body, a cleaning disk, a replaceable or washable cleaning pad and at least one handle, (b) cleaning a surface using the motorized lightweight handheld cleaning and polishing apparatus and (c) replacing or washing the cleaning pad.

According to embodiments of the present invention, the motorized method may be used to clean and polish large, vertical glass, mirror, wooden, ceramic, marble and metal surfaces in homes, offices, hotels and vehicles.

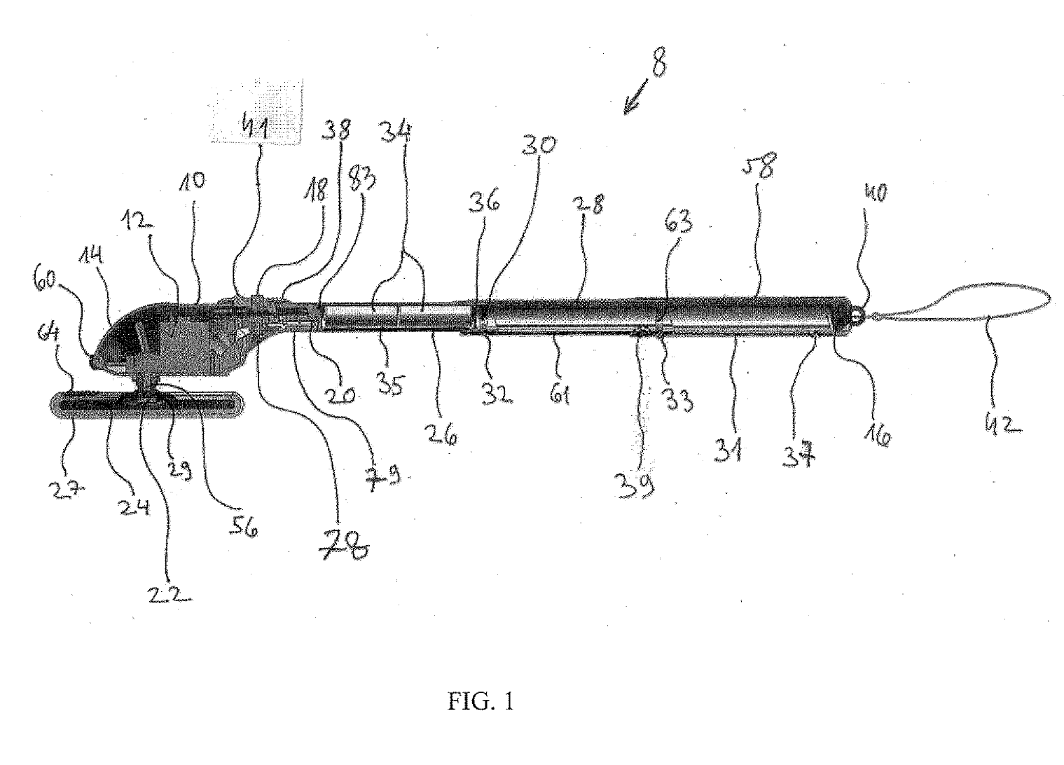

FIG. 1 illustrates a cross section of the motorized lightweight handheld cleaning and polishing apparatus with a telescoping handle in an open position, according to an embodiment of the present invention. The motorized lightweight handheld cleaning and polishing apparatus 8 includes a body 10 and a motor 12. Motor 12 delivers a rotary speed of at least 350 RPM to cleaning disk 24 and more preferably motor 12 delivers a rotary speed of 420-540 RPM to cleaning disk 24.

Vertical gear 14 is proximally attached to motor 12 and rotary axis 56. Rotary axis 56 provides a stall torque of at least 1 kilograms per centimeter to cleaning disk 24 and preferably a stall torque of substantially 4-6 kilograms per centimeter. Semi resilient guard 60 is attached to, or integrally formed with, body 10. Semi resilient guard 60 protects body 10 in use from impact and the like. Cleaning disk 24 is attached to rotary axis 56 by way of a hollow attachment 29.

Cleaning disk 24 may include a magnet 22 securing cleaning disk 24 to rotary axis 56. Multi-layered cleaning pad 27 is affixed to cleaning disk 24. Elastic disk fastener 64 may be used to secure multi-layered cleaning pad 27 to cleaning disk 24. Alternatively, synthetic glue-less patch may be used to secure multi-layered cleaning pad 27 to cleaning disk 24.

Multi-layer cleaning pad 27 may be a chamois pad, a fabric pad, a nonwoven pad, a paper pad, a muslin pad, an abrasive pad, a polishing pad or a sanding pad. Multi-layer cleaning pad 27 may include a plurality of pads stacked together, enabling removal of worn out pad thereby revealing a fresh pad.

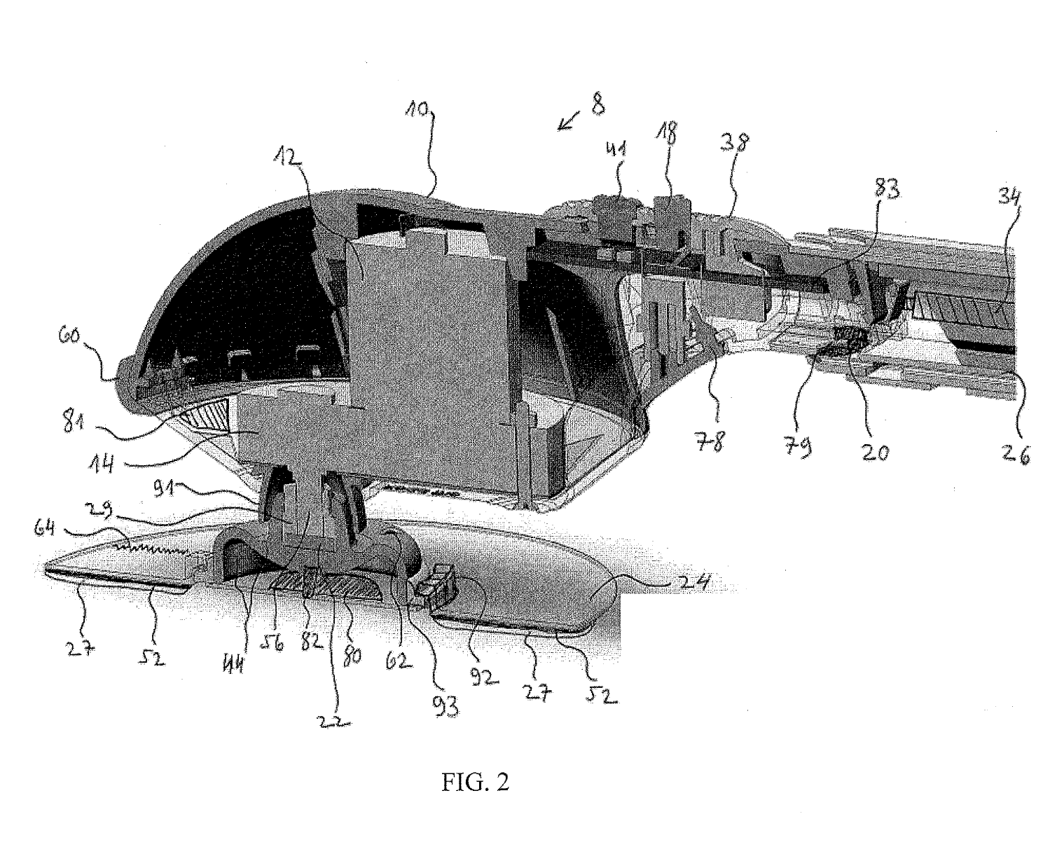

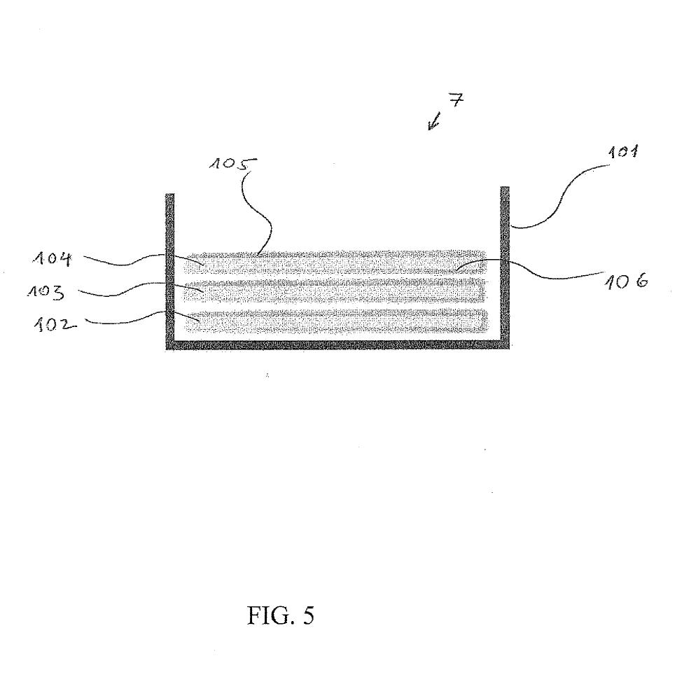

Optionally, a magazine of disposable pads for polishing and cleaning surfaces are stacked together, wherein the pads are preferably formed of recycled materials (The cleaning pads magazine is illustrated in FIG. 5). Disposable cleaning pads may be stacked in the magazine where the pads upper side is coated with thin nylon layer used to attach cleaning pad 27 to adhesive 52 (illustrated in FIG. 2) permanently attached to cleaning disk 24. The coating thin layer is used to preserve the cleaning pads shape and resilience which may be especially beneficial if the cleaning pads are disposable and are comprised of degradable material. Coating the cleaning pad upper side with a nylon layer is given as a non limiting example of a coating layer according to embodiments of the present invention and other polymers may be used to coat the cleaning pad upper side and are in the scope or the present invention.

Multi-layer cleaning pad 27 may be washable for repeated multiple use. Alternatively, multi-layer cleaning pad 27 may be substantially constructed by a degrading material for one time use.

Multi-layer cleaning pad 27 may include an extended rim, sticking out beyond the perimeter of the cleaning disk 24 by 1 to 15 millimeters protecting the rotating cleaning disk 24 and allowing the motorized lightweight handheld polishing and cleaning apparatus 8 to clean also the frames of the surfaces. Multi-layer cleaning pad 27 may include further a brush or sponge soaked with cleaning liquid.

An operating switch 38 may be preferably ergonomically located in body 10. A safety switch 18 may also be provided for preventing inadvertent use. Miniature light bulb 41 is used to indicate operational status and might be turned on also during battery charging.

Recharging input connection 78 is used for charging power source 34. Preferably, power source 34 may include batteries such as: AAA battery, AA battery, C cell battery, D cell battery and CR123 battery. External power source may be connected to input connection 78 and may be used to power the present invention motorized lightweight handheld apparatus.

Slide locker 20 may be used to lock body 10 to handle 26 mounted on the lower posterior portion 79 of body 10. According to embodiments of the present invention, handle 26 may be used to accommodate power source 34. Contact board 36 may be used to secure power source 34 and to close an electrical circuit 83.

Pressing slide locker button 20 releases body 10 from handle 26 and allows replacing power source 34. Preferably, a rounded first biased pin 30 is readily accommodated by an aperture 39 formed in a distal end of central link 28 of handle 26.

According to embodiments of the present invention, handle 26 may be extended using central link 28. At an extremity of handle 26, a first slide pin 30 is accommodated by a first aperture 39 formed in central link 28 of handle 26 enabling extension of central link 28. A displacement of central link 28 brings about an extension of central link 28 and handle 26 such that first slide pin 30 protrudes from first aperture 39 formed in central link 28 and secures handle 26 by second aperture 32 formed in central link 28. A handle recess 61 formed in handle 26 may be provided along central link 28 enabling lateral displacement of central link 28 along handle 26.

Protrusion 35 may be attached to, or integrally formed with handle 26 for further facilitating lateral displacement of central link 28 along handle 26. At an extremity of central link 28 a second slide pin 63 together with a third aperture 37 formed in rear link 58 readily secure rear link 58 to central link 28.

Displacing rear link 58 for the purpose of extending handle 26 displaces second slide pin 63 relative to central link 28 such that second slide pin 63 protrudes from third aperture 37 formed in rear link 58 and secures central link 28 by fourth aperture 33 formed in rear link 58. A link recess 31 formed in rear link 58 is provided along rear link 58 facilitating lateral displacement of rear link 58 along recess 61 formed in central link 28 of handle 26. Thus, handle 26, central link 28 and rear link 58 are readily collapsible, thereby enabling a user to extent and contract the extension to body 10 and reach hard to reach, vertical, high or distant surfaces.

Inserting second slide pin 63 into fourth aperture 33 locks rear link 58 to central link 28 thereby yielding an effective extension of handle 26. Thus, motorized lightweight handheld cleaning and polishing apparatus 8 is especially suited to cleaning high and/or external window panes without creating a potentially perilous situation for the user and is readily capable of cleaning non glass-like surfaces absent a preliminary scouring/scrubbing process. A further displacement of rear link 58 will release second slide pin 63 from aperture 33 formed in rear link 58 and bring about a re-insertion of second slide pin 63 into an opening 37 formed in rear link 58. Thus, rear link 58 will return to the original position relative to central link 28.

Advantageously, power source battery 34 is located at the distal end link of the telescopic handle, adjacent to motor 12, connected reliably and conveniently to the motor and not affected by the movements of the other links of the telescopic handle.

Reinsertion of central link 28 displaces first slide pin 30 substantially outwardly out of second aperture 32 formed in central link 28 thereby first slide pin 30 re-insertion to aperture 39 enables collapsing telescopic handle 26 to switch to its folded position. Cover 16 is provided for securing lanyard loop 42 to the motorized lightweight handheld polishing and cleaning apparatus 8, Optionally, cover 16 may be attached to the posterior securing link 58 by securing ring 40. Lanyard loop 42 may be electrostatic protected.

Thus, inadvertent dropping or mishandling of motorized lightweight handheld cleaning and polishing apparatus 8 is substantially prevented. Additional methods of securing motorized lightweight handheld cleaning and polishing apparatus 8 according to techniques known in the art are envisaged and are in the scope of the present invention.

The term “Shore hardness” as used herein, shall include, but will not be limited to the hardness of plastics which is most commonly measured by the Shore® (Durometer) test or Rockwell hardness test. Both methods measure the resistance of plastics toward indentation and provide an empirical hardness value that doesn't necessarily correlate well to other properties or fundamental characteristics. Shore Hardness, using either the Shore A or Shore D scale, is the preferred method for rubbers/elastomers and is also commonly used for ‘softer’ plastics such as polyolefins, fluoropolymers, and vinyls; The Shore A scale is used for ‘softer’ rubbers while the Shore D scale is used for ‘harder’ ones.

Many other Shore hardness scales, such as Shore 0 and Shore H hardness, exist but are only rarely encountered by most people in the plastics industry; the Shore hardness is measured with an apparatus known as a Durometer and consequently is also known as Durometer hardness'. The hardness value is determined by the penetration of the Durometer indenter foot into the sample. Because of the resilience of rubbers and plastics, the indentation reading may change over time—so the indentation time is sometimes reported along with the hardness number. The ASTM test method designation is ASTM D2240 00 and is generally used in North America. Related methods include ISO 7619 and ISO 868; DIN 53505; and JIS K 6301, which was discontinued and superseded by JIS K 6253.”

FIG. 2 illustrates a lengthwise cross-section of the motorized lightweight handheld cleaning and polishing apparatus and the cleaning disk, according to an embodiment of the present invention.

Cleaning disk 24 may be constructed of a semi resilient material having a Shore hardness of substantially 90. Cleaning disk 24 may be constructed of poly carbonate or other stiff plastic material known in the art. Cleaning disk 24 may be easily displaceable for enhanced cleaning properties of objects such as frames, window frames and uneven surfaces. According to embodiments of the present invention, a plurality of cleaning disks 24 may be readily interchanged using the present invention motorized lightweight handheld apparatus 8 facilitating enhanced cleaning and polishing capabilities.

Cleaning disk 24 may be easily and efficiently displaced by disconnecting magnet 22 from rotation axis 56. Alternatively cleaning disk 24 may be easily and efficiently displaced by releasing tongue 92 from pin 93 by rotation.

For the purpose of cleaning and polishing large surfaces, cleaning disk 24 may be at least 9 centimeters in diameter. Multi-layer cleaning pad 27 may be attached to or integrally formed with cleaning disk 24. Optionally, cleaning pad 27 is attached to cleaning disk 24 by Yupo Tako™ or Velcro™ or similar adhesives 52 known in the art.

Bias 44 of cleaning disk 24 may be constructed of a semi resilient material having a Shore hardness of at least 80.

Bias 44 of cleaning disk 24 may be formed in a cross section substantially resembling that of the letter “W” thereby readily facilitating three dimensional displacement of cleaning disk 24 whilst substantially contemporaneously applying a wide variety of pressure by the user. Advantageously, the “W” shaped bias 44 formed in cleaning disk 24 is geared towards enhanced shock absorbing properties.

Another advantage of the “W” shaped bias 44 formed in cleaning disk 24 is that it reduces the friction coefficient and saves energy and/or enhances the cleaning capabilities of cleaning disk 24.

A plurality of apertures may be formed in the “W” shape bias 44 formed in cleaning disk 24 facilitating flow of air and/or debris from the surface being cleaned or polished and enhancing ease of rotational displacement of cleaning disk 24.

Replaceable cleaning cartridge 80 may be included at the base of cleaning disk 24 providing cleaning and polishing materials and/or liquid for further enhancing the cleaning and polishing capabilities of cleaning disk 24 and multi-layer cleaning pad 27. Optionally, a replaceable cleaning cartridge 81 is accommodated by body 10 providing cleaning and polishing material and/or liquid through pipe aperture 82 forked in the opening of “W” shape bias 44 for further enhancing the cleaning and polishing capabilities of cleaning disk 24 and cleaning pad 27.

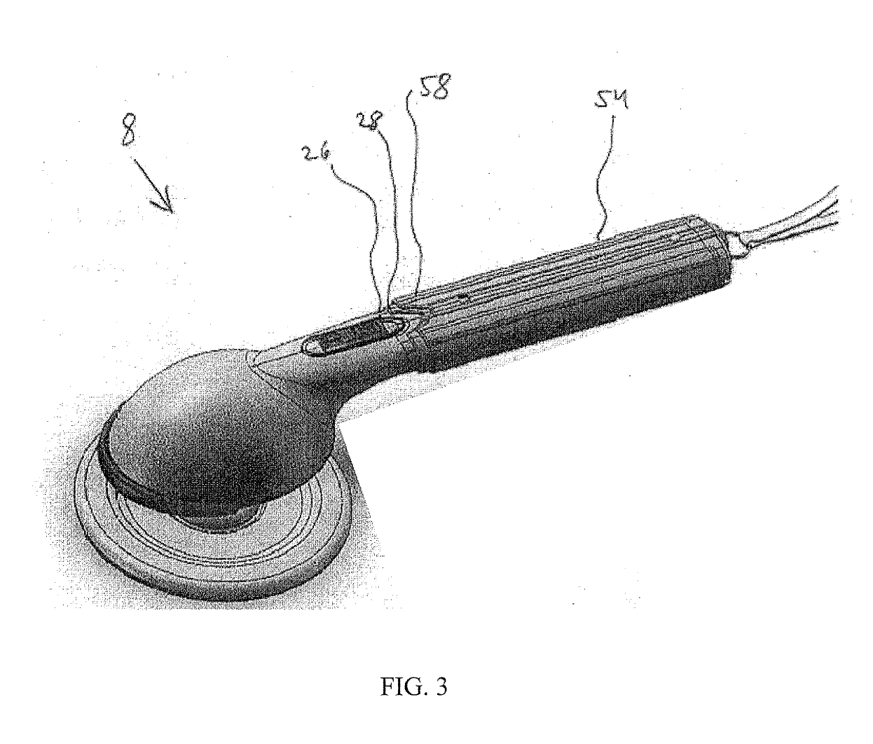

FIG. 3 illustrates the motorized lightweight handheld apparatus 8 with a built-in telescoping handle in a folded position, according to an embodiment of the present invention. Built-in telescopic handle 54 is shown in a collapsed position, attached to or integrally formed with handle 26. Internal telescopic member 28 is shown inside the outer telescopic member 58 of the present invention motorized lightweight handheld apparatus 8. Other extension members may be added to the motorized lightweight handheld apparatus handle and are in the scope of the present invention.

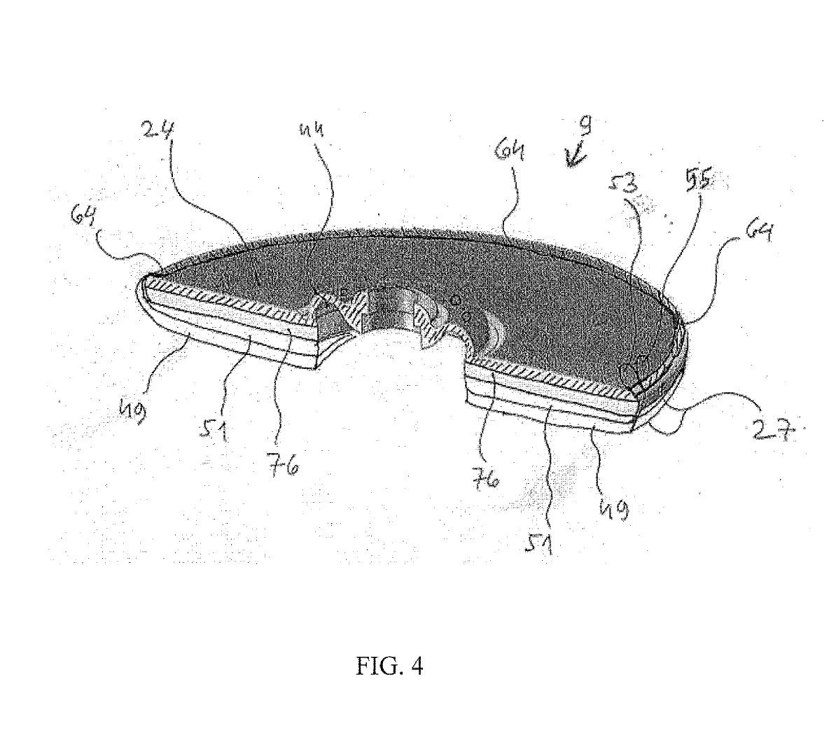

FIG. 4 illustrates a cross-section of a multi-layer disposable cleaning pad, according to an embodiment of the present invention. Multi-layer cleaning pad 27 may be substantially constructed of non-woven fabric, paper or similar “scratch proof” material. An exterior layer 49 and an interior layer 51 of multi-layer cleaning pad 27 are illustrated in FIG. 4. An exterior release tab 53 is provided for releasing exterior layer 49 and an interior release tab 55 is provided for releasing interior layer 51. Exterior layer 49 and interior layer 51 of multi-layer cleaning pad 27 are preferably attached to or integrally formed with a band 64. Optionally, Exterior layer 49 and interior layer 51 of multi-layer cleaning pad 27 may include layer adhered to each other.

Band 64 may be used to secure multi-layer cleaning pad 27 to cleaning disk 24. Depending on the cleaning and polishing process being completed, the user may elect to remove exterior layer 49 or interior layer 51 of multi-layer cleaning pad 27 by deploying exterior release tab 53 and releasing exterior layer 49 or deploying interior release tab 55 for releasing interior layer 51.

A soft layer 76 may be attached to or integrally formed with cleaning disk 24 for “softening” the displacement and/or rigidity of the cleaning and polishing process with cleaning disk 24. Alternatively, a soft layer 76 may be attached to or integrally formed with cleaning pad 27 and with cleaning disk 24 for “softening” the displacement and/or rigidity of the cleaning and polishing process with cleaning pad 27 and with cleaning disk 24.

Preferably, soft layer 76 is substantially constructed of material selected from the group consisting of: a spongy material, a silicone and a vulcanized material.

Safety bell 91 (illustrated in FIG. 2) may be comprised of semi resilient material and is attached to the motorized lightweight handheld apparatus body 10. Safety bell 91 prevents the entrance of hair and any other materials to rotation axis 56.

FIG. 5 illustrates an external cleaning pads magazine, according to an embodiment of the present invention. The present invention motorized lightweight handheld polishing and cleaning apparatus may be provided with an external cleaning pads magazine 7. The external cleaning pads magazine may include disposable pads 102, 103 and 104 stacked one on each other. Each pad having an upper side 105 and lower side 106. The upper side of each cleaning pad 105 may be coated with a thin nylon layer used to attach firmly the upper cleaning pad to the adhesive (FIG. 2, 52) fixed permanently to the cleaning disk bottom.

It is envisaged that the motorized lightweight handheld cleaning and polishing apparatus according to the present invention readily lends itself to industrial cleaning and polishing processes, including but not limited to cleaning offices, hotels, vehicles cleaning facility and general maintenance.

Advantageously, the present invention motorized lightweight handheld cleaning and polishing apparatus may be used for cleaning and polishing large glass, mirror, wooden, ceramic, marble and metal surfaces.

Another advantage of the motorized lightweight handheld cleaning and polishing apparatus described above is that large surfaces at homes, offices, hotels and vehicles may be cleaned and polished manually.

Another advantage of the motorized lightweight handheld cleaning and polishing apparatus described above is that the cleaning disks may be replaced easily and efficiently allowing cleaning of various large surfaces and surface frames.

Another advantage of the motorized lightweight handheld cleaning and polishing apparatus described above is that its multi-layer cleaning pads may be washable or disposable.

Furthermore, the present invention motorized lightweight handheld cleaning and polishing apparatus telescopic handle allows cleaning large surfaces that may be hard to access.

Furthermore, the present invention motorized lightweight handheld cleaning and polishing apparatus replaceable cleaning cartridge provides cleaning material and or liquid to enhance the cleaning capabilities of the apparatus.

In summary, the motorized lightweight handheld cleaning and polishing apparatus of the present invention improves the prior art cleaning and polishing devices by introducing a motorized handheld lightweight cleaning and polishing apparatus used for cleaning and polishing large, vertical and hard to access surfaces and surface frames efficiently using replaceable cleaning disks and multi-layer cleaning pads.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description. While preferred embodiments of the present invention have been shown and described, it should be understood that various alternatives, substitutions, and equivalents can be used, and the present invention should only be limited by the claims and equivalents thereof.

What is claimed is:

1. A motorized lightweight handheld polishing and cleaning apparatus used to clean and polish large and hard to access surfaces, the apparatus comprising:
a body, further comprising a motor used to rotate a cleaning disk;
a cleaning disk operationally attached to a rotary axis of a vertical gear of said motor; and
at least one handle.

2. The motorized lightweight handheld polishing and cleaning apparatus according to claim 1, comprising further a multi-layer cleaning pad, wherein said multi-layer cleaning pad comprises a plurality of pads stacked together enabling removal of an outer worn out pad thereby revealing a fresh pad.

3. The motorized lightweight handheld polishing and cleaning apparatus according to claim 2, wherein said multi-layer cleaning pad is provided with an exterior release tabs for releasing the exterior layers and an interior release tabs for releasing the interior layers.

4. The motorized lightweight handheld polishing and cleaning apparatus according to claim 2, wherein said multi-layer cleaning pad is washable and intended for repeated multiple usages.

5. The motorized lightweight handheld polishing and cleaning apparatus according to claim 2, wherein said multi-layer cleaning pad comprises further a brush.

6. The motorized lightweight handheld polishing and cleaning apparatus according to claim 2, wherein said multi-layer cleaning pad is disposable and is constructed from degrading materials aimed for one time use

7. The motorized lightweight handheld polishing and cleaning apparatus according to claim 1, wherein said cleaning disk comprises further an adhesive fixed to the cleaning disk bottom.

8. The motorized lightweight handheld polishing and cleaning apparatus according to claim 7, wherein an external cleaning pads magazine is provided, and wherein the upper side of each cleaning pad in said provided cleaning pads magazine is coated with a thin nylon layer used to attach firmly said upper cleaning pad to said adhesive fixed to said cleaning disk.

9. The motorized lightweight handheld polishing and cleaning apparatus according to claim 2 or 7, wherein said cleaning pads comprises further an extended rim, sticking out beyond a perimeter of said cleaning disk by 1 to 15 millimeters, protecting said rotating cleaning disk and allowing said handheld lightweight polishing and cleaning apparatus to clean surface frames.

10. The motorized lightweight handheld polishing and cleaning apparatus according to claim 2 or 7, wherein said cleaning pads comprises further a sponge soaked with a cleaning liquid.

11. The motorized lightweight handheld polishing and cleaning apparatus according to claim 2, wherein said multi-layer cleaning pad is constructed from a material selected from the group consisting of: chamois, fabric, paper, muslin, nonwoven and abrasive.

12. The motorized lightweight handheld polishing and cleaning apparatus according to claim 1, wherein said at least one handle is a built-in folded telescoping handle allowing cleaning and polishing large, high and hard to access surfaces.

13. The motorized lightweight handheld polishing and cleaning apparatus according to claim 1, wherein said motor delivers a rotation speed of at least 350 RPM to said cleaning disk.

14. The motorized lightweight handheld polishing and cleaning apparatus according to claim 1, wherein said motor delivers a rotation speed of 420-540 RPM to said cleaning disk.

15. The motorized lightweight handheld polishing and cleaning apparatus according to claim 1, wherein said motor rotary axis provides a stall torque of at least 1 kilogram per centimeter.

16. The motorized lightweight handheld polishing and cleaning apparatus according to claim 1, wherein said motor rotary axis provides a stall torque of 4-6 kilograms per centimeter.

17. The motorized lightweight handheld polishing and cleaning apparatus according to claim 1, wherein said cleaning disk includes a magnet for securing said cleaning disk to said rotary axis.

18. The motorized lightweight handheld polishing and cleaning apparatus according to claim 1, wherein a plurality of cleaning disks are provided and wherein said cleaning disks are detachable and replaceable.

19. The motorized lightweight handheld polishing and cleaning apparatus according to claim 1, further comprising elastic disk fastener for securing said cleaning pads to said cleaning disk.

20. The motorized lightweight handheld polishing and cleaning apparatus according to claim 1, wherein said cleaning disk cross section resembles the letter W facilitating three dimensional displacements of said cleaning disk, reducing the friction coefficient, reducing the vibrations and enhancing the cleaning capabilities of the W shape cleaning disk

21. The motorized lightweight handheld polishing and cleaning apparatus according to claim 1, comprising further a plurality of apertures formed in the W shape cleaning disk used to clear debris from the cleaned surfaces and to enhance ease of rotation of said cleaning disk.

22. The motorized lightweight handheld polishing and cleaning apparatus according to claim 1, comprising further a replaceable cleaning cartridge that provides cleaning and or polishing material and or liquid for further enhancing the cleaning and polishing capabilities of said cleaning disk and said multi-layer cleaning pads.

23. The motorized lightweight handheld polishing and cleaning apparatus according to claim 1, wherein said power source is selected from the group consisting of: external power source, batteries and rechargeable batteries.

24. The motorized lightweight handheld polishing and cleaning apparatus according to claim 19, wherein said batteries are selected from the group consisting of: AAA battery, AA battery, C cell battery, D cell battery and CR123 battery.

25. The motorized lightweight handheld polishing and cleaning apparatus according to claim 1, comprising further an electrostatic protected lanyard used further to protect and secure the handheld polishing and cleaning apparatus from falling down.

26. A motorized method for cleaning and polishing surfaces, the method comprises the steps of:
providing a motorized lightweight handheld cleaning and polishing apparatus comprising further a body, a cleaning disk, cleaning pads and at least one handle;
cleaning surfaces using said motorized lightweight handheld apparatus; and
replacing or washing said cleaning pads.

27. The motorized method for cleaning and polishing surfaces according to claim 26, comprising further the step of providing a multi-layer cleaning pad, wherein said multi-layer cleaning pad comprises a plurality of pads stacked together enabling removal of an outer worn out pad thereby revealing a fresh pad.

28. The motorized method for cleaning and polishing surfaces according to claim 26, comprising further the step of providing an adhesive fixed to the cleaning disk bottom.

29. The motorized method for cleaning and polishing surfaces according to claim 26, comprising further the step of providing an external cleaning pads magazine, and wherein the upper side of each cleaning pad in said provided cleaning pads magazine is coated with a thin nylon layer used to attach firmly said upper cleaning pad to said adhesive fixed to said cleaning disk.

30. The motorized method for cleaning and polishing surfaces according to claim 26, wherein said surfaces are selected from the group consisting of: glass, mirror, wooden, ceramic, marble and metal surfaces in homes, offices, hotels and vehicles.
